(19) United States
(12) Patent Application Publication
(10) Pub. No.: US 2017/0359519 A1
(43) Pub. Date: Dec. 14, 2017

(54) VEHICLE INFORMATION SYSTEM AND METHOD

(71) Applicant: GENERAL MOTORS LLC, Detroit, MI (US)

(72) Inventor: GARY J. HARDY, SAINT CLAIR SHORES, MI (US)

(73) Assignee: GENERAL MOTORS LLC, Detroit, MI (US)

(21) Appl. No.: 15/177,079

(22) Filed: Jun. 8, 2016

(51) Int. Cl. H04N 5/232; G05D 1/00; B60R 1/00; H04N 5/44

(52) U.S. Cl. CPC H04N 5/23293; H04N 5/44; G05D 1/0088; B60R 1/00; B60R 2300/80; B60R 2300/105; B60R 2300/20; B60R 2300/8066

(57) ABSTRACT

Methods, systems, and vehicles are provided that include information systems including a display disposed about the interior of a vehicle. The display is positioned within the vehicle to be viewable by an occupant of the vehicle who is not looking forward through the vehicle windshield and/or or towards displays, gauges or instrumentation primarily positioned for viewing by a forward-looking occupant. The information system may be coupled to receive data from one or more vehicle control systems or controllers, from cameras disposed within the interior or on the exterior of the vehicle, from one or more sensors and/or from a telematics system. The information system configures the data for display on the display.

### TECHNICAL FIELD

The technical field generally relates to vehicle infotainment and telematics systems, and more particularly, the technical field relates to systems and methods to present and display information to an operator or passenger of a vehicle.

### BACKGROUND

Vehicle technology has evolved to permit autonomous, semi-autonomous, and otherwise automated vehicles. Automated vehicles offer unprecedented freedom to a vehicle operator to engage in tasks within the vehicle apart from attending to the operation of the vehicle. However, while automated vehicles allow the operator to divert their attention from operation of the vehicle for brief time periods, operators are still encouraged to observe the vehicle surroundings and status of the vehicle's systems, including the autonomous operating systems.

Accordingly, it is desirable to provide systems and methods to present vehicle surrounding information, operating information and data and other forms of information and data to an occupant, such as the operator or a passenger, of a vehicle during autonomous operating modes and when the occupant is facing other than forward in the vehicle. It is also desirable to provide methods, systems, and vehicles incorporating such systems and utilizing such methods. Furthermore, other desirable features and characteristics of the herein described non-limiting embodiments will be apparent from the subsequent detailed description and the appended claims, taken in conjunction with the accompanying drawings and the foregoing technical field and background.

### SUMMARY

In a first non-limiting example, a display is disposed within the interior of a vehicle with the display coupled to information system. The display is positioned within the vehicle to be viewable by an occupant of the vehicle who is not looking forward through the vehicle windshield and/or or towards displays, gauges or instrumentation primarily positioned for viewing by a forward-looking occupant. The information system may be coupled to receive data from one or more vehicle control systems or controllers, from cameras disposed within the interior or on the exterior of the vehicle, from one or more sensors and/or from a telematics system. The information system configures the data for display to the operator via the display.

In another non-limiting example, a method provides information to an occupant of a vehicle who is not looking forward through the vehicle windshield and/or towards displays, gauges or instrumentation primarily positioned for viewing by a forward-looking occupant. The method includes obtaining information from one or more vehicle control systems or controllers, from cameras disposed within the interior or on the exterior of the vehicle, from one or more sensors and/or from a telematics system. The obtained information is then configured for display and displayed on at least one display positioned within the vehicle to be viewable by the occupant.

In another non-limiting example, a vehicle is provided. The vehicle includes a display disposed within the interior of a vehicle with the display being coupled to an information system. The display is positioned within the vehicle to be viewable by an occupant of the vehicle who is not looking forward through the vehicle windshield and/or or towards displays, gauges or instrumentation primarily positioned for viewing by a forward-looking occupant. The information system may be coupled to receive data from one or more vehicle control systems or controllers, from cameras disposed within the interior or on the exterior of the vehicle, from one or more sensors and/or from a telematics system. The information system configures the data for display to the occupant via the display.

### DESCRIPTION OF THE DRAWINGS

One or more examples will hereinafter be described in conjunction with the following drawing figures, wherein like numerals denote like elements, and

FIG. 1 is a graphic depiction of a communication system that may be adapted in accordance with herein described non-limiting embodiments;

FIG. 2 is a schematic view illustrating an information system in accordance with herein described non-limiting embodiments;

FIG. 3 is a first graphic depiction of a portion of a vehicle that may be adapted in accordance with herein described non-limiting embodiments;

FIG. 4 is a second graphic depiction of a portion of a vehicle that may be adapted in accordance with herein described non-limiting embodiments;

FIG. 5 is a schematic diagram of a display in accordance with a herein described non-limiting embodiment; and

FIG. 6 is a flow diagram illustrating a method in accordance with a herein described, non-limiting embodiment.

### DETAILED DESCRIPTION

The following detailed description is merely exemplary in nature and is not intended to limit application and uses of the herein described embodiments. Furthermore, there is no intention to be bound by any expressed or implied theory presented in the preceding technical field, background, brief summary or the following detailed description.

Methods, systems, and vehicles are provided that utilize a communication system that may include infotainment systems and telematics systems along with land network and call center functions, linkages to vehicle systems and controls and camera or imaging devices to deliver information to an occupant of the vehicle, e.g., the driver or a passenger.

In a first non-limiting example, at least one display is disposed within the interior of a vehicle with the display being coupled to an information system. The display is positioned within the vehicle to be viewable by an occupant of the vehicle who is not looking forward within the vehicle and/or or towards displays, gauges or instrumentation primarily positioned for viewing by a forward-looking occupant. The information system may be coupled to receive data from one or more vehicle control systems or controllers, from cameras or imaging devices disposed within the interior or on the exterior of the vehicle, from one or more sensors and/or from a telematics system. The information system configures the data for display on the display.

In another non-limiting example, a method provides information to an occupant of a vehicle who is not looking forward within the vehicle and/or towards displays, gauges or instrumentation primarily positioned for viewing by a forward-looking occupant. The method includes obtaining information from one or more vehicle control systems or controllers, from cameras or imaging devices disposed within the interior or on the exterior of the vehicle, from one or more sensors and/or from a telematics system. The obtained information is then configured for display and is displayed on at least one display positioned within the vehicle to be viewable by the occupant.

In another non-limiting example, a vehicle is provided. The vehicle includes a display disposed with the interior of a vehicle with the display being coupled to an information system. The display is positioned within the vehicle to be viewable by an occupant of the vehicle who is not looking forward through the vehicle windshield and/or towards displays, gauges or instrumentation primarily positioned for viewing by a forward looking occupant. The information system may be coupled to receive data from one or more vehicle control systems or controllers, from cameras or imaging devices disposed within the interior or on the exterior of the vehicle, from one or more sensors and/or from a telematics system. The information system configures the data for display on the display.

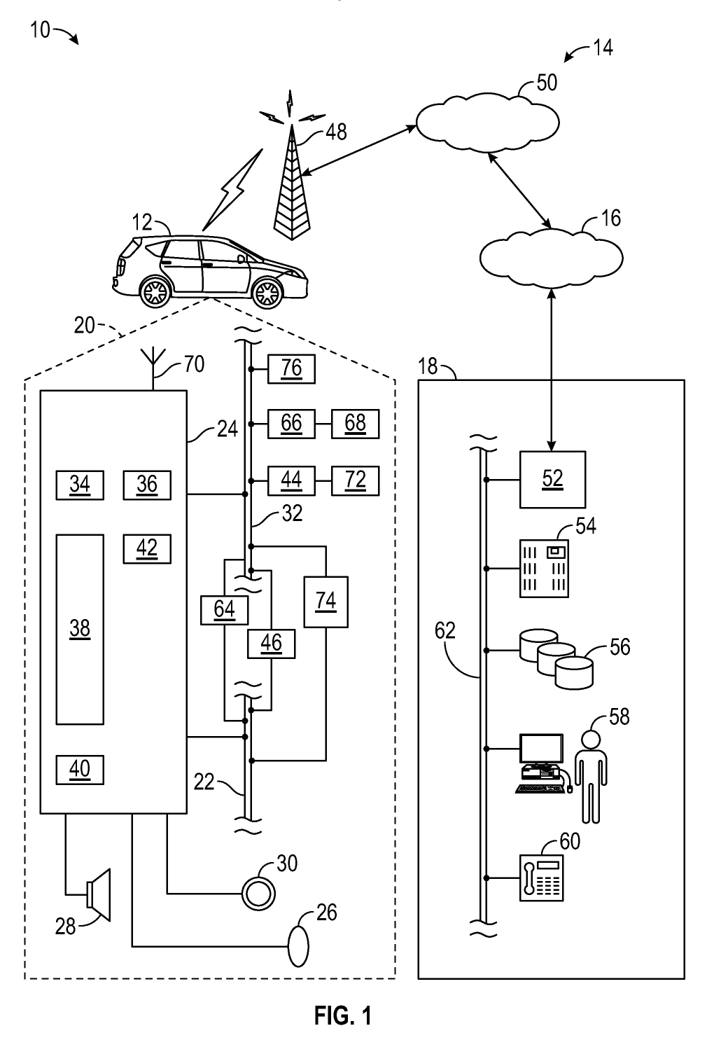

With reference to FIG. 1, there is shown a non-limiting example of a communication system 10 that may be used together with examples of the apparatus/systems disclosed herein or to implement examples of the methods disclosed herein. Communication system 10 generally includes a vehicle 12, a wireless carrier system 14, a land network 16 and a call center 18. It should be appreciated that the overall architecture, setup and operation, as well as the individual components of the illustrated system are merely exemplary and that differently configured communication systems may also be utilized to implement the examples of the systems and methods disclosed herein. Thus, the following paragraphs, which provide a brief overview of the illustrated communication system 10, are not intended to be limiting.

Vehicle 12 may be any type of mobile vehicle such as a motorcycle, car, truck, recreational vehicle (RV), boat, plane, etc., and is equipped with suitable hardware and software that enables it to communicate over communication system 10. Some of the vehicle hardware 20 is shown generally in FIG. 1 including a telematics unit 24, a microphone 26, a speaker 28, and buttons and/or controls 30 connected to the telematics unit 24. Operatively coupled to the telematics unit 24 is a network connection or vehicle bus 32. Examples of suitable network connections include a controller area network (CAN), a media oriented system transfer (MOST), a local interconnection network (LIN), an Ethernet, and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is an onboard device that provides a variety of services through its communication with the call center 18, and generally includes an electronic processing device 38, one or more types of electronic memory 40, a cellular chipset/component 34, a wireless modem 36, a multi-mode antenna 70, and a navigation unit containing a GPS chipset/component 42. In one example, the wireless modem 36 includes a computer program and/or set of software routines adapted to be executed within electronic processing device 38.

The telematics unit 24 may provide various services including: turn-by-turn directions and other navigation-related services provided in conjunction with the GPS chipset/component 42; airbag deployment notification and other emergency or roadside assistance-related services provided in connection with various crash and/or collision sensor interface modules 66 and collision sensors 68 located throughout the vehicle; and/or infotainment-related services where music, internet web pages, movies, television programs, videogames, and/or other content are downloaded by an infotainment center 46 operatively connected to the telematics unit 24 via vehicle bus 32 and audio bus 22. The telematics unit 24 may furthermore support or enable autonomous vehicle operation. The above-listed services are by no means an exhaustive list of all the capabilities of telematics unit 24, but are simply an illustration of some of the services that the telematics unit may be capable of offering. It is anticipated that telematics unit 24 may include a number of additional components in addition to and/or different components from those listed above.

Vehicle communications may use radio transmissions to establish a communication channel with wireless carrier system 14 so that both voice and data transmissions can be sent and received. Vehicle communications are enabled via the cellular chipset/component 34 for voice communications and the wireless modem 36 for data transmission. Any suitable encoding or modulation technique may be used with the present examples, including digital transmission technologies, such as TDMA (time division multiple access), CDMA (code division multiple access), W-CDMA (wideband CDMA), FDMA (frequency division multiple access), OFDMA (orthogonal frequency division multiple access), etc.

Multi-mode antenna 70 services the GPS chipset/component 42, the cellular chipset/component 34 and other radio transmissions.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and call center 18 to communicate with the occupants through audible speech. The vehicle hardware and in particular the HMI may also include one or more buttons and/or controls 30 for enabling a vehicle occupant to activate or engage one or more of the vehicle hardware components 20. For example, one of the buttons and/or controls 30 may be touch screen activated or electronic pushbuttons used to initiate voice communication with call center 18 (whether it be a human such as advisor 58 or an automated call response system). In another example, one of the buttons and/or controls 30 can be used to initiate emergency services.

The audio component 64 is operatively connected to the vehicle bus 32 and the audio bus 22. The audio component 64 receives analog or digital information, such as analog or digital broadcast content via a broadcast source (not depicted), rendering it as sound via the audio bus 22. Digital information is additionally received via the vehicle bus 32. The audio component 64 provides amplitude modulated (AM) and frequency modulated (FM) radio, satellite broadcast radio, compact disc (CD), digital video disc (DVD), and multimedia functionality independent of the infotainment center 46. Audio component 64 may contain a speaker system (not depicted), or may utilize speaker 28 via arbitration on vehicle bus 32 and/or audio bus 22.

The vehicle crash and/or collision detection sensor interface 66 is operatively connected to the vehicle bus 32. The collision sensors 68 provide information to the telematics unit 24 via the crash and/or collision detection sensor interface 66 regarding the severity of a vehicle collision, such as the angle of impact and the amount of force sustained.

Vehicle sensors 72, connected to various sensor interface modules 44 are operatively connected to the vehicle bus 32. Example vehicle sensors include but are not limited to gyroscopes, accelerometers, magnetometers, emission detection, and/or control sensors, and the like. Example sensor interface modules 44 include powertrain control, climate control, and body control, to name but a few.

Wireless carrier system 14 may be a cellular telephone system or any other suitable wireless system that transmits signals between the vehicle hardware 20 and land network 16. According to an example, wireless carrier system 14 includes one or more cell towers 48, base stations and/or mobile switching centers (MSCs) 50, as well as any other networking components required to connect the wireless carrier system 14 with land network 16. As appreciated by those skilled in the art, various cell tower/base station/MSC arrangements are possible and could be used with wireless carrier system 14.

Land network 16 can be a conventional land-based telecommunications network that is connected to one or more landline telephones, and that connects wireless carrier system 14 to call center 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

Call center 18 is designed to provide the vehicle hardware 20 with a number of different system back-end functions and, according to the example shown here, generally includes one or more switches 52, servers 54, databases 56, advisors 58, as well as a variety of other telecommunication/computer equipment 60. These various call center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either advisor 58 or an automated response system, and data transmissions are passed on to a modem or other piece of telecommunication/computer equipment 60 for demodulation and further signal processing. The modem or other telecommunication/computer equipment 60 may include an encoder, as previously explained, and can be connected to various devices such as a server 54 and database 56. For example, database 56 could be designed to store subscriber profile records, subscriber behavioral patterns, or any other pertinent subscriber information. Although the illustrated example has been described as it would be used in conjunction with a call center 18 that is manned, it will be appreciated that the call center 18 can be any central or remote facility, manned or unmanned, mobile or fixed, to or from which it is desirable to exchange voice and data.

An information system 74 is operably coupled at least to bus 32 and optionally to bus 22. While depicted in the exemplary embodiment as a separate system or component of the vehicle 12, it will be appreciate that the information system 74 may be made a part of the telematics unit 24, an autonomous operating system (not depicted) or other systems and components of the vehicle 12.

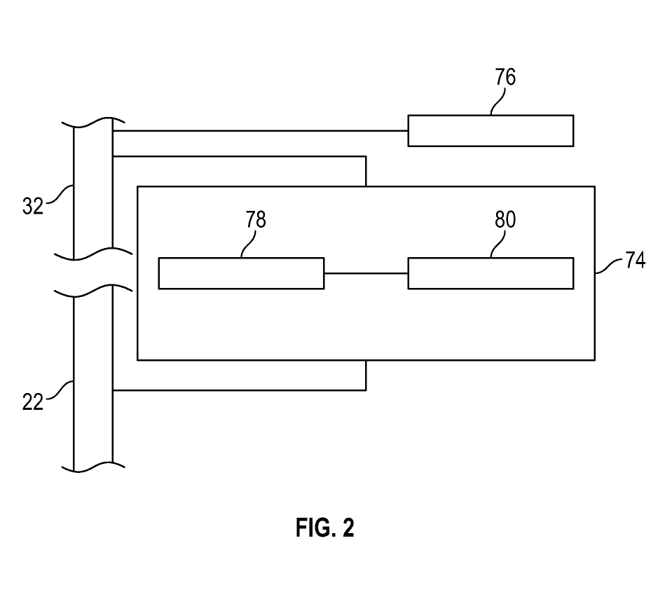

One or more cameras or imaging devices, depicted as cameras 76, may provide image data directly to the bus 32 (as depicted in FIGS. 1 and 2) or to the bus 32 via the telematics unit 24. Cameras 76 disposed on the exterior of the vehicle 12 may provide image data corresponding to various views of the perimeter of the vehicle including at least forward and rearward looking views. Additional cameras 76 disposed within the interior may provide image data corresponding to various views of the seating, storage and other areas of the vehicle 12 interior. The cameras 76 may be provided as a part or component of the information system 74, or alternatively, the cameras 76 may be cameras provided on or within the vehicle 12 to support any number of vehicle systems, such as an autonomous operating systems, the General Motors' “Supercruise” capability, parking and maneuvering systems and the like. Being coupled to the bus 32 and the bus 22, the information system 74 may access vehicle operating data available from various vehicle sensors and systems that may be addressed or obtained via the bus 32 and audio and other media via the bus 22.

With reference to FIG. 2, the information system 74 includes a data processing unit 78 and at least one display 80 disposed within the vehicle 12. The data processing unit 78 may include a dedicated processing device or a general processing device (not depicted) with an associated set of operating instructions, memory and communication interfaces as is well known in the art.

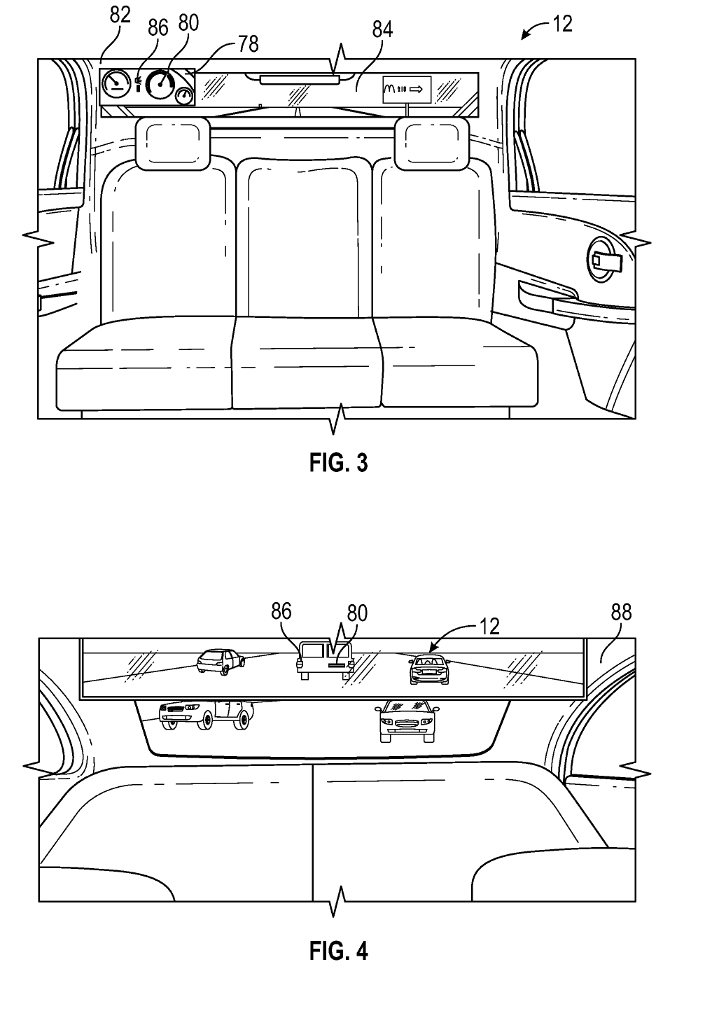

FIGS. 3 and 4 each show a display 80 in non-limiting exemplary embodiments disposed in the vehicle in an orientation to permit viewing by an occupant who is not looking forward in the vehicle 12 and/or or towards displays, gauges or instrumentation primarily positioned for viewing by a forward looking occupant. This may be the case, for example, when the vehicle 12 is placed into an autonomous operating mode and the operator has diverted attention from looking forward in and from the vehicle 12 to looking into the rear interior of the vehicle. While always encouraged to observe the forward direction and operation of the vehicle during all modes of operation, autonomous operation does offer the possibility for the operator briefly to divert attention away from the forward area of the vehicle 12.

As depicted in the embodiment of FIG. 3, the display 80 is disposed in the rear of the vehicle 12 in an upper corner 82 adjacent a rear window 84. In the exemplary configuration of FIG. 3, the display 80 has a display surface 86 facing forward within the vehicle 12.

As depicted in the embodiment of FIG. 4, the display 80 is disposed in the rear of the vehicle 12 and extends along substantially the entire width of a rear header portion 88 of the vehicle 12. In the embodiment depicted in FIG. 4, the display 80 has a forward facing display surface 86.

With continuing reference to FIGS. 1-4, the information system 74 is operative, for example, when the vehicle 12 is in an autonomous operating mode but also during any other operating mode, to present a variety of information to an occupant who is not facing forward in the vehicle 12 and/or towards displays, gauges or instrumentation primarily positioned for viewing by a forward looking occupant, via the display 80. The type of information to be presented may be vehicle operating information such as vehicle speed, direction, fuel quantity, oil and coolant temperatures, and the like. This type of vehicle operating information is collected by the information system 74 from various vehicle 12 sensors and systems via the bus 32. The information system 74 may also display a forward looking view obtained from cameras 76 and communicated to the information system 74 via the bus 32. The information system 76 may also display navigation, surrounding, voice, text and data communications received via the telematics unit 24. As will be appreciated, the occupant may remain informed as to the current operating conditions of the vehicle 12 and the state of its surroundings. The occupant may furthermore send and receive communication data: voice, text and the like, while not facing forward in the vehicle, but while facing away from the forward portion of the vehicle and while not having visibility of displays, gauges or instrumentation primarily positioned for viewing by a forward looking occupant.

While the embodiments depicted in FIGS. 3 and 4 illustrate a single display 80, it will be appreciated that multiple displays may be provided within the vehicle 12. For example, displays may be disposed in both right and left upper corners of the interior rear of the vehicle 12 and/or along the interior sides of the vehicle 12. The display 80 may be integrated into one or more pieces of interior trim of the vehicle, into seat or seat portions and may fold out or down from interior trim pieces (not depicted).

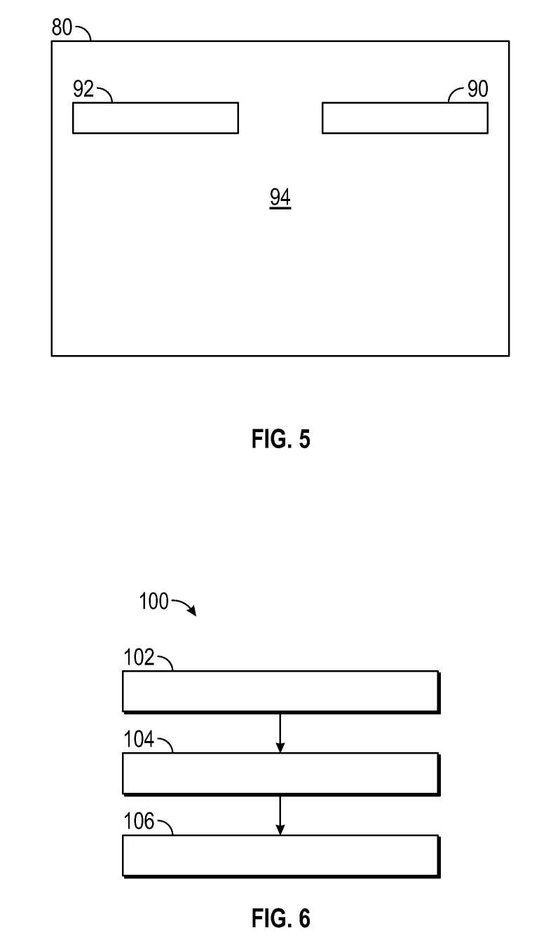

In yet another alternative arrangement of the display 80 depicted in FIG. 5. As illustrated, the rear of the vehicle 12 may be enclosed with the rear window 84 being replaced by the display 80. The display 80 may be segmented, and three segments 90, 92 and 94 are depicted although more or fewer segments may be employed. As FIG. 5 shows, a first segment 90 may depict image data from a forward or rearward facing external camera 76 providing a virtual forward or rearward looking view of the direction of travel of the vehicle 12. A second segment 92 may depict vehicle operating information, such as speed, direction, fuel quantity, oil and coolant temperatures, and the like. A third segment 94 may, while the segment 90 provides a rearward view, provide a forward view. Any of the segments may provide a communication interface to initiate or accept a voice communication or to create or render text using the microphone 26 and/or controls/buttons 30.

The data selected for display by the information system 76 on a display 80 may be user configurable via voice commands or inputs received via microphone 26 and/or controls/buttons 30 of the telematics unit 24 or via other user controls and interfaces. The data displayed may be configured to change dynamically/automatically to provide image data, operating data, communications data or other data as new, changing or priority data is received by the information system 76.

With reference to FIG. 6 a method 100 provides information to an occupant of a vehicle 12 who is not looking forward through the vehicle windshield and/or towards displays, gauges or instrumentation primarily positioned for viewing by a forward looking occupant. The method includes obtaining data (102) from one or more vehicle control systems or controllers, from cameras disposed within the interior or on the exterior of the vehicle, from one or more sensors and/or from a telematics system. A display 80 is provided (104) within the vehicle 12, and is oriented within the vehicle 12 for viewing by an occupant who is not facing forward in the vehicle, but is facing away from the forward portion of the vehicle and further while not having visibility of displays, gauges or instrumentation primarily positioned for viewing by a forward looking occupant. The information system 76 processes the information and displays (106) the information on the display 80 provided and disposed within the vehicle.

It will be appreciated that the disclosed methods, systems, and vehicles may vary from those depicted in the Figures and described herein. For example, the communication system 10, the vehicle 12, the information system 76 including the display 80 and/or various components thereof may vary from that depicted in FIGS. 1-5 and described in connection therewith. In addition, it will be appreciated that the process 100 may vary in the number and/or order of steps from that depicted in FIG. 6 and/or described above in connection therewith.

While at least one example has been presented in the foregoing detailed description, it should be appreciated that a vast number of variations exist. It should also be appreciated that the example or examples are only examples, and are not intended to limit the scope, applicability, or configuration of the disclosure in any way. Rather, the foregoing detailed description will provide those skilled in the art with a convenient road map for implementing the example or examples. It should be understood that various changes can be made in the function and arrangement of elements without departing from the scope of the appended claims and the legal equivalents thereof.

What is claimed is:

1. An information system comprising:
a display disposed within an interior of a vehicle, the display being operatively coupled to an information processor, and the display further being positionable within the vehicle to be viewable by an occupant of the vehicle who is not looking forward through a vehicle windshield or towards displays, gauges or instrumentation primarily positioned for viewing by a forward looking occupant,
the information processor is operatively coupled to receive data from at least one of a vehicle control system or a vehicle controller, a camera disposed within the interior or on the exterior of the vehicle, a sensor, and a telematics system, wherein the information processor is operable to configure the data for display on the display.

2. The system of claim 1, wherein the data comprise image data of a camera positioned to view a forward direction of the vehicle.

3. The system of claim 1, wherein the data comprises operating data of the vehicle.

4. The system of claim 1, wherein the data comprise communication data.

5. The system of claim 1, wherein the information system is a portion of a telematics system of the vehicle.

6. The system of claim 1, wherein the information system is a portion of an autonomous control system of the vehicle.

7. The system of claim 1, wherein the display comprises multiple displays, and data is displayed on each of the multiple displays.

8. The system of claim 1, wherein the display has multiple display segments, and data is displayed on each of the multiple display segments.

9. A method of providing information to an occupant of a vehicle comprising:
providing a display within the vehicle such that the display is viewable by the occupant when the occupant is not looking forward within the vehicle or towards displays, gauges or instrumentation primarily positioned for viewing by a forward looking occupant;
obtaining data from at least one of a vehicle control system, a vehicle controller, an imaging device disposed within an interior of the vehicle, a second imaging device disposed on an exterior of the vehicle, a sensor disposed within the vehicle and a telematics system disposed within the vehicle to provide obtained information; and
displaying the obtained information on the display.

10. The method of claim 9, wherein the display comprises multiple displays, and displaying the obtained information comprises displaying a first obtained information on a first of the multiple displays and displaying a second obtained information, different than the first obtained information, on a second of the multiple displays.

11. The method of claim 9, wherein the display comprises multiple display segments, and displaying the obtained information comprises displaying a first obtained information on a first of the multiple display segments and displaying a second obtained information, different than the first obtained information, on a second of the multiple display segments.

12. A vehicle comprising:
an information system, the information system comprising a display to be disposed within an interior of a vehicle, the display being operatively coupled to an information processor, and the display further being positionable within the vehicle to be viewable by an occupant of the vehicle who is not looking forward through the vehicle windshield or towards displays, gauges or instrumentation primarily positioned for viewing by a forward looking occupant,
the information processor is operatively coupled to receive data from at least one of vehicle control systems or controllers, cameras disposed within the interior or on the exterior of the vehicle, sensors and a telematics system, wherein the information processor is operable to configure the data for display on the display.

13. The vehicle of claim 12, wherein the data comprise image data of a camera positioned to view a forward direction of the vehicle.

14. The vehicle of claim 12, wherein the data comprises operating data of the vehicle.

15. The vehicle of claim 12, wherein the data comprise communication data.

16. The vehicle of claim 12, wherein the information system is a portion of a telematics system of the vehicle.

17. The vehicle of claim 12, wherein the information system is a portion of an autonomous control system of the vehicle.

18. The vehicle of claim 12, wherein the display comprises multiple displays, and data is displayed on each of the multiple displays.

19. The vehicle of claim 12, wherein the display has multiple display segments, and data is displayed on each of the multiple display segments.

20. The vehicle of claim 12, wherein the vehicle is an autonomously operated vehicle.
